(19) United States
(12) Patent Application Publication
(10) Pub. No.: US 2015/0379679 A1
(43) Pub. Date: Dec. 31, 2015

(54) Single Read Composer with Outputs

(71) Applicant: Changliang Wang, Bellevue, WA (US)

(72) Inventor: Changliang Wang, Bellevue, WA (US)

(21) Appl. No.: 14/315,085

(22) Filed: Jun. 25, 2014

(51) Int. Cl. G06T 1/60; G06F 1/32; G06T 1/20

(52) U.S. Cl. CPC G06T 1/60; G06T 1/20; G06F 1/3275; G06F 1/3265

(57) ABSTRACT

A processing unit for generating multiple output items for output to a display or encoder. The processing unit may include a memory that stores data that will be used by a composer to generate the multiple output items. The processing unit may include a composer that executes only a single memory read operation when obtaining the data and splits the data to generate the multiple output items. The composer also may perform a function on the data before the data is split if all of the multiple output items require the data to undergo this function. The processing unit may also include a number of output buffers that each receive an output item from the composer and deliver the output item to an output such as a display or encoder.

### TECHNICAL FIELD

This disclosure relates generally to a single read composer with multiple outputs and composing method. More specifically, the disclosure relates to improving the energy and computational efficiency of composers with multiple output items.

### BACKGROUND ART

in computing devices, the composition, combining, or compositing of graphics is often undertaken in the graphics processing unit (GPU) by a composition engine or composer, one example being a 2D GPU composition engine. These composition engines may receive one or multiple layers of input and combine these layers together to produce an output. Often multiple outputs are requested from the same input layer data. This type of composition is used in many areas including gaming, video playback on local monitors through HDMI, wireless display, and for other encoding purposes. Obtaining the multiple input layer data through memory reads and processing this input data is both computationally and power intensive. Currently, to generate multiple outputs a composition engine will redundantly perform multiple memory reads of the same input data and iterate through the entire composition process for each output needed. This process involves repetitive memory reads of the same inputs and repetitive computations on the same data. Reducing the number of memory reads and computations in a composition engine would help control power consumption and allow improved performance particularly where computation and power resources are limited.

### BRIEF DESCRIPTION OF THE DRAWINGS

The following detailed description may be better understood by referencing the accompanying drawings, which contain specific examples of numerous features of the disclosed subject matter.

FIG. 1 is a block diagram of a system with a composer to generate multiple output items;

FIG. 2 is a block diagram of a composer showing multiple inputs, functions, and multiple outputs;

FIG. 3 is a block diagram of composer generating multiple output items with a single input;

FIG. 4 is a process flow diagram of a method for generating multiple output items with a composer;

FIG. 5 is a block diagram illustrating additional variations in output number and format; and

FIG. 6 is a block diagram showing exemplary functions performed by a composer and exemplary logic for maintaining output item quality.

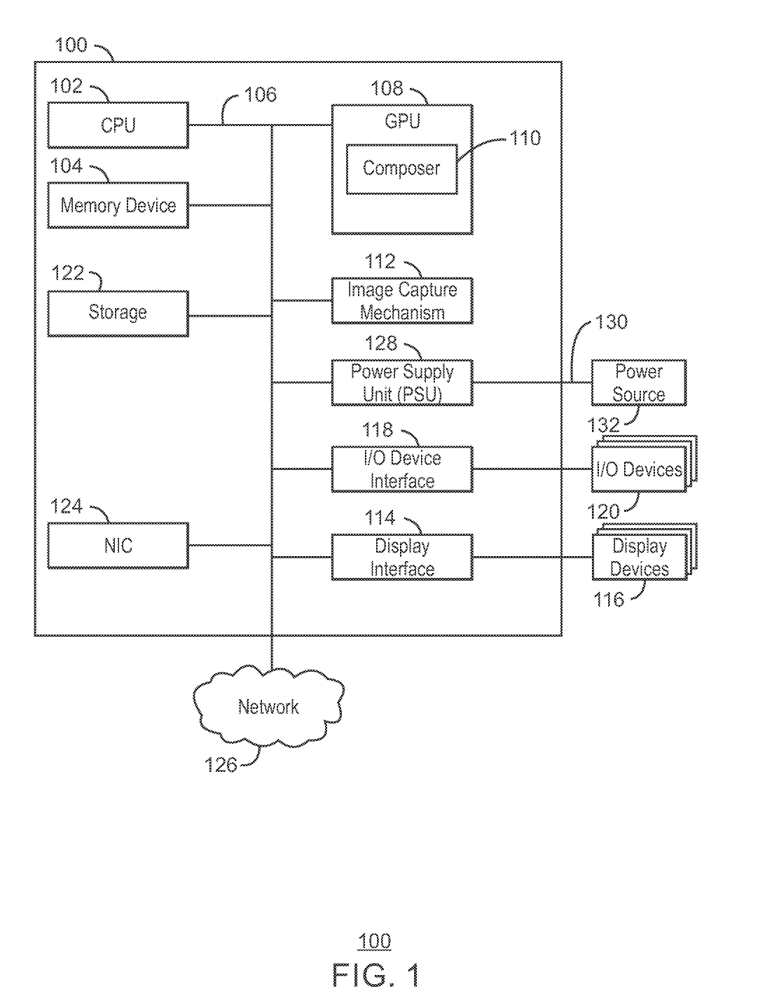

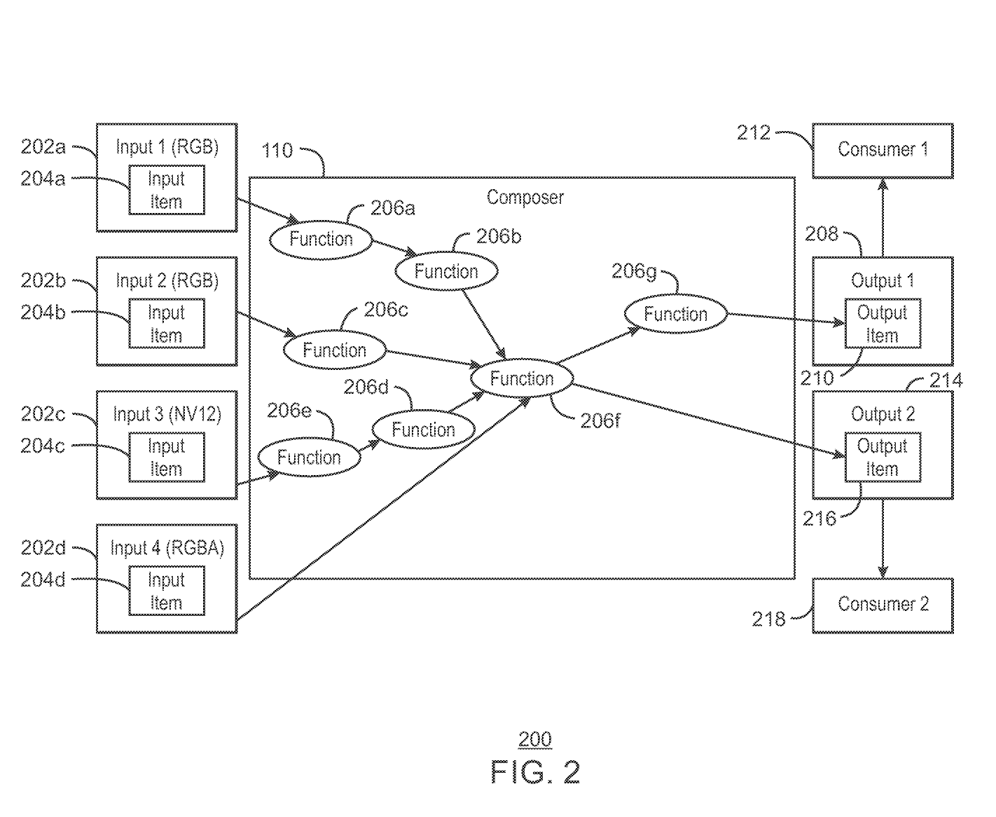

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In computing devices and especially in mobile devices such as tablets and phones, a composer may need to compose multiple input layers or prepare a layer for a particular output or number of outputs. As used herein a composer includes display engines, composition engines, 2D engine, or any other engine that composes and blends at least one input for multiple outputs. This may include composing layers for game, video playback on local monitors and HDMI, and also composing layers for wireless display. Controlling power consumption by a composer during the composition of layers is a critical task as each memory read of input layers can be a power intensive as well as performance decreasing activity. In addition to composition of layers, a composer may also support color space conversion, scaling, rotation, mirroring, alpha blending, and other similar functions. While some composition engines support multiple inputs and generates one output, the composer here disclosed may generate multiple outputs with only one memory read operation per input item.

The need for multiple output capable composers is growing. This need includes cases where only one input is present. One instance is where the single input has a format that needs conversion for two different colors formats for a camera. If in this instance, the camera output has a NV21 format and a display output in a YUY2 format, then composition is needed to convert an input to each format. In previous composition engines, at least two separate memory read operations would be needed to obtain data from input items for composition for each of the two formats. However, with the current composer, only one memory read operation is needed and the data of the input item is composed for the multiple outputs simultaneously.

The need for a multi-output composer is also seen in an instance where multiple input buffers require composition for two output buffers, for example, when there is more than one monitor. This may include when separate output buffer formats may vary between type of monitors such as local monitors, HDMI, or wireless display monitors. With pervious composition engines, data for two output buffer formats would be generated by making a two separate memory read operations, and a round trip through the composition engine even though the input layers are the same, and the functions are nearly the same. These previous compositions would result in extra memory reads and extra GPU composition time, as various composition functions would need to be performed twice. The unwelcome cost of the extra memory reads becomes most apparent when there are multiple input surfaces and they are large as this takes up valuable memory read bandwidth as well as the power for each read. Regardless of if older composition engines used fixed pipeline or programmable methods, these composition engines would be composing separately for each of the two outputs. Instead, the present composer enables multiple outputs by allowing the removal of the extra memory read and duplicated composition steps. An example of this can be visualized more specifically in FIG. 2 herein.

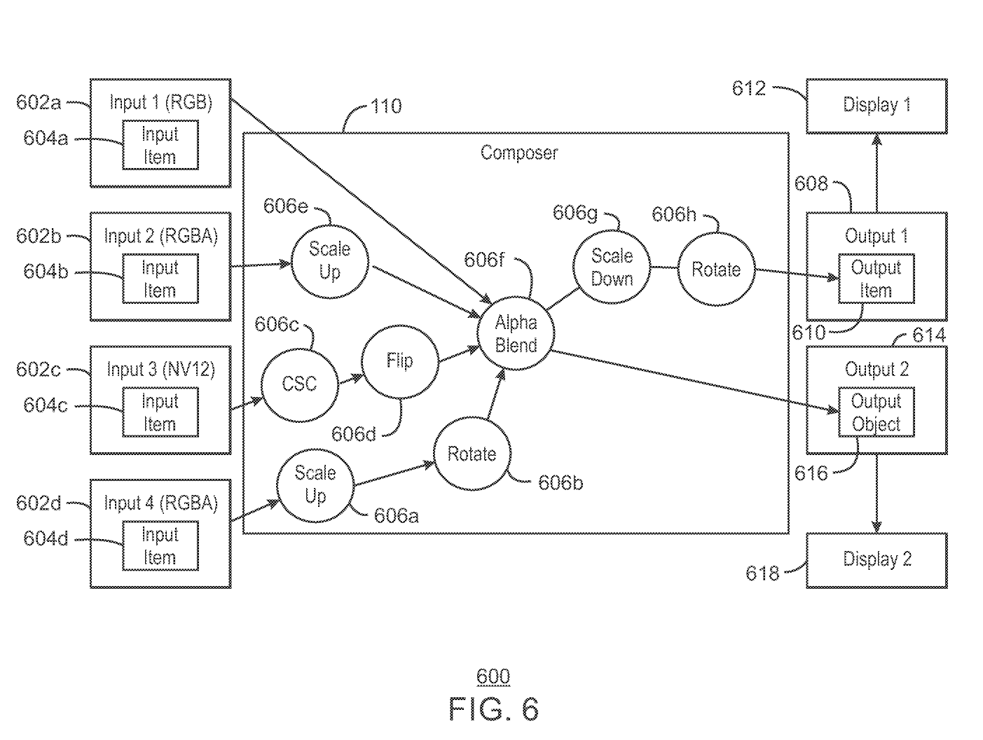

The composer is configurable and programmable to allow specification of the functions performed for each output. When possible, the functions performed may be combined and ordered as specified to improve the performance of the composer. A combination may have the goal of minimizing the total number, time, or computational power needed to generate all of the outputs. Further, the actual order these functions are performed in may assist in these goals by allowing repeatable functions to be merged and completed only once. Functions may be repeatable if multiple outputs are generated from the same inputs and in generating each of the output formats, the same functions will be applied to the inputs. Merging functions to avoid repeating them multiple times for each output may reduce the computation time and power needed in generating the needed outputs. An example of this can be visualized more specifically in FIGS. 2 and 6 seen herein.

Enabling multiple composer outputs may generate meaningful savings in the form of memory bandwidth use. These gains are particularly meaningful in bandwidth constrained devices and high resolutions. For example, in the case of a composer with two outputs being used for a 4 k surface, Table 1, shows the memory bandwidth saved based on the number of input layers at 4 k resolution being composed. This savings is a result of no longer needing to duplicate the memory read for each of the input layers.

TABLE 1
Memory read bandwidth savings based on # of layers composed

| Layers | Memory BW (read) |
|---|---|
| (3840*2160 px RGB) | Saving (60 fps) |
| 1 | 1.9 GB/s |
| 2 | 3.8 GB/s |
| 3 | 5.7 GB/s |

A further performance gain from the composer can be seen when approximating the energy savings to a platform using this composer. Each 1 GB/s of memory bandwidth saving translates to roughly ˜200 mw savings to the platform. In addition to memory bandwidth savings and energy savings, the minimized number of functions results in computational savings and in some embodiments GPU residency saving.

This multi-output composer may be enabled as a programmable composer or as a fixed function pipeline composer. A fixed function pipeline composer allowing multiple outputs may involve making a logical change in the way the composer is written and implemented to enables the composer to write to two or more buffers. A fixed function composer may refer to a fixed function API or a fixed function implementation in hardware. Either such implementation provides only a set number of operations for the composer to implement. Accordingly, enabling a fixed function composer would involve developing either the logic or hardware that would allow the splitting of data to create the multiple output items. A programmable composer that allows for multiple outputs may be implemented by writing a new function in the composer kernel and inserting it into the GPU for each output added.

As noted herein, the composer involves a single memory read operation while composing for multiple outputs. More specifically, the memory read operation occurs when the data from inputs, stored in input items go into the composer, and a memory write occurs when outputting to a buffer and then displayed or encoded. Within the composer, there is an internal cache so that between functions, there are no additional memory reads or writes. Furthermore, although it may herein referred to as a composition and thereby imply multiple layers or inputs, single layer inputs and single inputs are also contemplated where a single layer or single data input is being split to multiple outputs. In one instance, a single input may need to be converted to two different formats which can be accomplished by the presently disclosed composer.

FIG. 1 is a block diagram of a system with a composer to generate multiple output items, in accordance with an embodiment. The computing device 100 may be, for example, a laptop computer, desktop computer, ultrabook, tablet computer, mobile device, or server, among others. The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the computing device 100 may include more than one CPU 102.

The computing device 100 may also include a graphics processing unit (GPU) 108. As shown, the CPU 102 may be coupled through the bus 106 to the GPU 108. The GPU 108 may be configured to perform any number of graphics functions and actions within the computing device 100. For example, the GPU 108 may be configured to render or manipulate graphics images, graphics frames, videos, or the like, to be displayed to a user of the computing device 100. The GPU 108 includes a composer 110. In examples of the subject innovation, the composer 110 is used to generate multiple output items from the data of at least one input item using only one memory read operation per input.

The memory device 104 can include random access memory (RAM), read only memory (ROM), flash memory, or any other suitable memory systems. For example, the memory device 104 may include dynamic random access memory (DRAM). The computing device 100 includes an image capture mechanism 112. In some embodiments, the image capture mechanism 112 is a camera, stereoscopic camera, scanner, infrared sensor, or the like.

The CPU 102 may be linked through the bus 106 to a display interface 114 configured to connect the computing device 100 to one or more display devices 116. The display device(s) 116 may include a display screen that is a built-in component of the computing device 100. Examples of such a computing device include mobile computing devices, such as cell phones, tablets, 2-in-1 computers, notebook computers or the like. The display device 116 may also include a computer monitor, television, or projector, among others, that is externally connected to the computing device 100.

The CPU 102 may also be connected through the bus 106 to an input/output (I/O) device interface 118 configured to connect the computing device 100 to one or more I/O devices 120. The I/O devices 120 may include, for example, a keyboard and a pointing device, wherein the pointing device may include a touchpad or a touchscreen, among others. The I/O devices 120 may be built-in components of the computing device 100, or may be devices that are externally connected to the computing device 100.

The computing device 100 may also include a storage device 122. The storage device 122 is a physical memory such as a hard drive, an optical drive, a thumbdrive, an array of drives, or any combinations thereof. The storage device 122 may also include remote storage drives. The computing device 100 may also include a network interface controller (NIC) 124 may be configured to connect the computing device 100 through the bus 106 to a network 126. The network 126 may be a wide area network (WAN), local area network (LAN), or the Internet, among others.

The computing device 100 and each of its components may be powered by a power supply unit (PSU) 128. The CPU 102 may be coupled to the PSU through the bus 106 which may communicate control signals or status signals between then CPU 102 and the PSU 128. The PSU 128 is further coupled through a power source connector 130 to a power source 132. The power source 132 provides electrical current to the PSU 128 through the power source connector 130. A power source connector can include conducting wires, plates or any other means of transmitting power from a power source to the PSU.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

FIG. 2 is a block diagram of a composer 110 showing multiple inputs 202, functions 206, and multiple outputs 208, 214. The multiple inputs 202, may provide streams of bytes, or data, as a layer which may represent graphics, a visual interface, a user interface, video, or any other layer for composing for an output. As indicated in the block diagram, each input, 202a-202d, may provide data in a different format, for example, red green blue color model (RGB), red green blue alpha color model (RGBA), NV12 and other YUV pixel formats, although other similar input and color space formats are also acceptable. The color formats YUV refers to a color space format typically used in encoding color images for display on screens. More specifically as an acronym YUV refers generally to the whole family of luminescence/chrominance color space formats or simply the way color information is encoded. Each input provides for manipulation by the composer 110, an input item 204 which may contain the data stream of each input 202, a packet of data, or any discrete amount of data which may be composed by the functions 206 of the composer 110 to provide to each output 208 an output item 210. The input item 204 may be a data buffer or any other region in physical memory or storage. Each output item, e.g. 210, is data or other information that represents the composition of the data from the various inputs. Output items may be stored on output buffers which may be physical regions in memory. Output buffers possess the capability to store output items and deliver them to outputs, e.g. 208, which may be for a particular consumer, e.g. Consumer 1, 212. A consumer may be a display such as a phone screen, computer monitor, television, or projector. A consumer may also be an encoder which encodes a buffer for transmission to a network. Specifically if the Consumer is an encoder, it may not directly display the composed output, but instead encode the output 208 and output item 210 to be saved to storage, prepared for transmittal to a non-local or remote device or display, or any other action which requires separate encoding of the output 208. The encoder may provide a way to encode an output buffer before sending it to a network for further action. For example, in a wireless display case, a consumer that is an encoder will encode an output buffer before sending the output buffer to a network.

The functions 206a-206g of the composer 110 that are visualized here are examples only, and may vary in number and actual action performed. Examples of possible actions for each function 206 include color space conversion, scaling, rotate, alpha blending, flipping, chroma keying, crop, aligning, transforming, shearing, and any combination or similar action thereof. Each function 206 may perform an action on the data from each input item 204 in order to compose the layers of each input 202 so that the proper output items 208 may be displayed or encoded as needed. In this example, the data of the input items 204 have functions 206 that first apply to the data of each input item individually, however also operate on the data of all input items at the same time where possible to save computational resources, e.g. 206f, without performing new memory read operations from the inputs 202. Following the last function to be applied for all outputs, the data in the composer may be split to allow the application of different functions to different data. Accordingly, other functions 206g may also be applied to ensure an output 210 is properly composed for an output 208 which may be displayed or encoded differently for Consumer 1, 212, rather than Consumer 2, 218. One example of needing to apply a function, 206g, after splitting may include where one output requires an output item that is larger than the other. Accordingly, this different output may require a function that scales up or down an output item 210 or 216, to fit its particular display dimensions.

Output items 210 and 216 may include streams of data for each output 208 and 214, respectively. Output items, 210 and 216, may also be in different sizes or formats in order to suit their respective outputs and the resulting displays. Each Consumer 212 and 218 may vary in multiple aspects including size, orientation, and color format, each requiring a separate output item from each output. As previously discussed, the composer may save resources including memory bandwidth, power, and GPU residency by providing multiple outputs by combining functions 206 applied to the data of the inputs 202 of the composer 110.

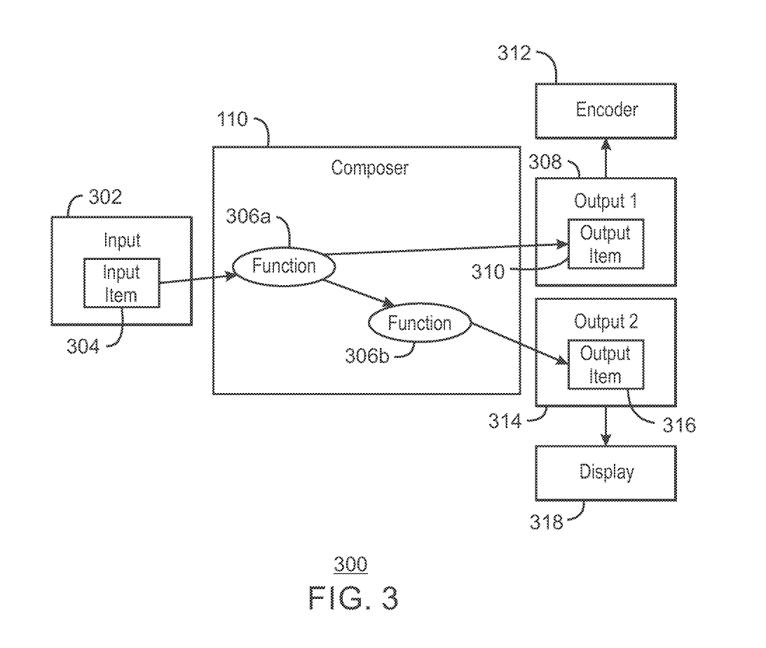

FIG. 3 is a block diagram of composer generating multiple output items with a single input 302. The single input 302 may have an input item 304 similar to the input items of FIG. 2. However, as there is only one input, or layer, the functions 306 needed to compose the data of the input item 304 for the multiple outputs will not need to combine functions with data from other input items. Instead, each function performed 306a-306b, will be to prepare the data to become the appropriate output item for each output, 308 and 314. The outputs may vary as is for an encoder 312 and the other for a display 318. The encoder may not directly display the composed output, but instead encode the output 308 and output item 310 to be saved to storage, prepared for transmittal to a non-local or remote device or display, or any other action which requires separate encoding of the output 308. The encoder may provide a way to encode an output buffer before sending it to a network for further action. The display 318 is similar to the displays described as a Consumer from FIG. 2, it should be noted however, that the composer 110, did not need to perform a separate memory read operation in order to provide for multiple outputs, even when one may be an encoder 312 and the other a display 318. Further, although the composer 110 only shows one input, this is merely an example to show that multiple inputs are not necessary. However, multiple inputs 302 are contemplated for the composer 110 which could still compose for multiple outputs such as the encoder 312 and display 318 shown here.

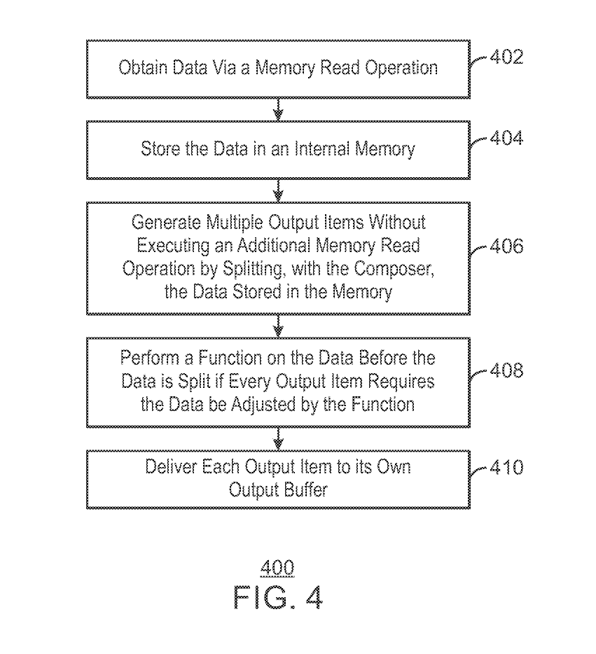

FIG. 4 is a process flow diagram of a method 400 for generating multiple output items with a composer. At block 402 the composer obtains data from an input item. As discussed herein, obtaining this data includes a sole memory read operation from each input item.

At block 404, the composer stores the obtained input item data in a physical internal memory region. This internal memory region is internal to the composer and processing unit rather than a physical memory location elsewhere in the system. This memory region may be a register, or cache located on the composer. The operations performed by the composer does not involve memory writes or multiple reads from external system memory. In one instance, the operations will be on a tile base, and the composer will have an internal cache to store a tile. A tile is data that represents a smaller region of the input image and can be 4K in size. The use of tiles allows the use of smaller and faster internal memories, such as caches and registers to be used as only a piece of the image is processes at a time rather than the whole image. The use of internal memory such as caches and registers avoids costly memory read and writes from memories outside the composer. These internal memory regions hold the tile, or data while it is being manipulated inside the composer and may also include an internal intermediate memory location or storage where data being manipulated by functions or combined from various input items may be stored temporarily until further manipulations are needed, or the data is sent to an output buffer.

At block 406, multiple output items are generated without executing an additional memory read operation by splitting, with the composer, the data stored in a memory region. The split multiple output items may be generated with the composer by producing copies that can be sent to each output or further manipulated. These further manipulations of split data may use the same functions as are used to manipulate the data from the inputs.

At block 408, a function may be performed on combined data, before the data is split. One benefit of applying a function to data prior to splitting it is seen in the reduction of the total number of functions that would need to be applied to split data to get the same result. The performing of a function at this time allows the combination of otherwise repetitive functions by instead allowing the application of a function to the same inputs for slightly differing output objects. As discussed herein, this function may perform a variety of actions upon input items such as color space conversions, scaling, rotating, alpha blending, flipping, chroma keying, cropping, aligning, transforming, shearing, and any other combination thereof. These functions are combined when possible to save computational resources such as GPU residency time. Further, the order these functions are performed in may desirably preserve the quality of the input item for output. For example, when possible, an input item should not be scaled down in size if it will later be scaled back up. Details of the input image may be lost upon a scaling down function that will not be preserved when scaled back up for a certain size display or encode output. Accordingly, functions should be ordered so that scaling down functions, when needed and possible, are not followed by scaling up functions.

The composer does not need to perform a function on every collection of data, depending on the provided data, the input data may already be in the proper format, size, and color space for a given output. Indeed, one advantage of having multiple outputs from a single composer is the ability to eliminate unneeded functions and duplicative memory read operations. Indeed, it is this splitting of the data within the composer that allows the composer to execute only a single memory read operation. By using the data already stored in the composer as an intermediate, the composer avoids the need to completely reread the same inputs and reproduce the functions for the input data simply to yield a slightly varied output item for a different output. Further, the composer may choose to order, combine, and even eliminate unneeded functions where possible to save on computational resources. The composer will, however, perform at least one function on the multiple output items, even if that function is a single scale function, for example.

At block 410, the composer delivers each output item to its own output buffer. Delivery to an output buffer places the output item in a physical memory region that allows the output item to be transmitted to any particular output such as a display or an encoder.

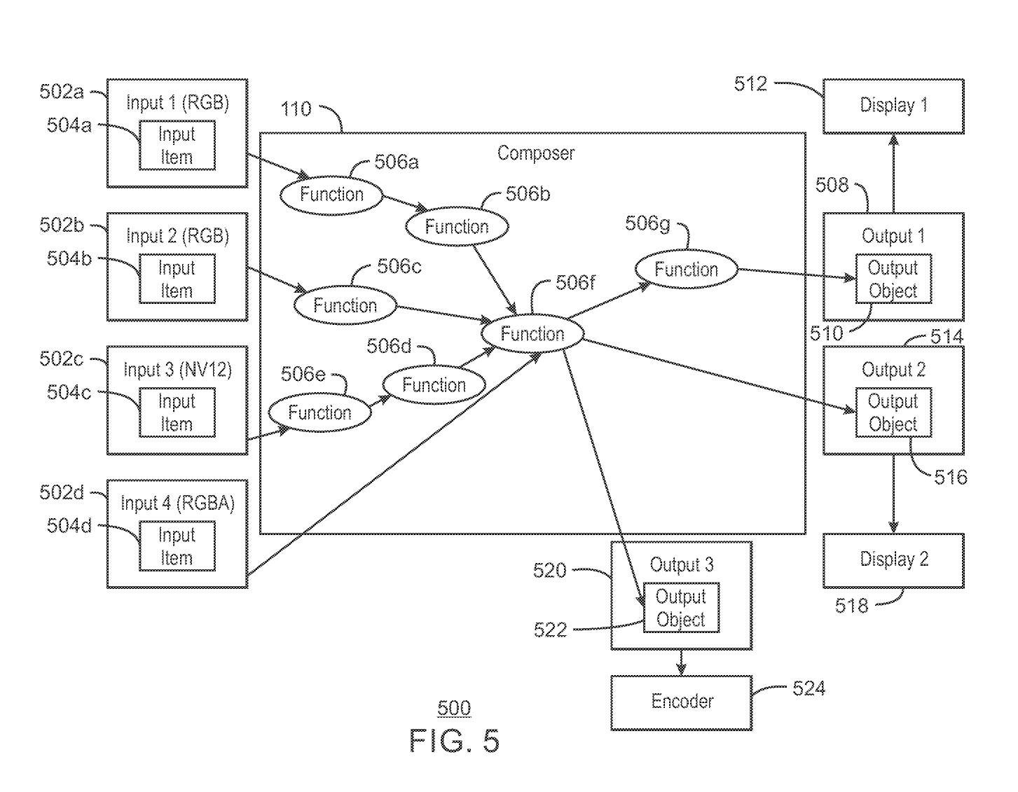

FIG. 5 is a block diagram illustrating additional variations in a composer's 110 ability as far as in output number and minimizing of functions. The multiple inputs 502, may provide a streams of bytes for a layer which may represent graphics, a visual interface, a user interface, video, or any other layer for composing for an output. As indicated in the block diagram, each input, 502a-502d, may have a different format, for example, red green blue color model (RGB), red green blue alpha color model (RGBA), NV12 and other YUV pixel formats, although other similar input formats are also acceptable. Each input 502 provides data from an input item 504 for composing by the composer 110. The data from the input item 504 may include a data stream of each input 202, a packet of data, or any discrete amount of data which may be composed by the functions 206 of the composer 110 to provide to each output 208 an output item 210.

The functions 506a-506g of the composer 110 that are visualized here are examples only, and may vary in number and actual action performed. Examples of possible actions for each function 506 include color space conversion, scaling, rotate, alpha blending, flipping, chroma keying, crop, aligning, transforming, shearing, and any combination or similar action thereof. Each function 506 may perform an action on the each the data in order to compose the layers of each input 502 so that the proper output items 508 may be displayed or encoded as needed. In this example, the data has functions 506a-506e that first apply to the data of each input item individually, however also operate on all data at the same time where possible to save computational resources, e.g. 506f, without performing new memory read operations from the inputs 502. It should also be noted that the data from input item 504d, in this example, did not require any functions be applied to it individually prior to function 506f where a function was applied to all data at once. This may occur when the input item is already in a format, size, or other condition that does not require a function be applied to it individually to compose it with other data. Other functions 506g may also be applied separately to ensure that each output 510, 514, and 520 is properly composed for an output 208 which may be displayed or encoded differently for Display 1, 512, rather than Display 2, 518, or an encoder, 524. This may include where one output is larger than the other and may require a function that scales up or down an output item 510, 516, or 522, for the respective display or encoder.

Output items 510, 516, and 522 may include streams of data for each output 508, 514, and 520, respectively. Output items 510, 516, and 522, may also be in different sizes or formats in order to suit their respective outputs and the resulting displays. Each display and encoder 508, 514, and 520 may vary in multiple aspects including size, orientation, and color format, each requiring a separate output item from each output. As previously discussed, the composer may save resources including memory bandwidth, power, and GPU residency by providing multiple outputs by combining functions 506 applied to the inputs 502 of the composer 110. As is further demonstrated by the composer 110 here disclosed, the number of outputs is not limited to two. Further, the outputs may be for any combination of displays and encoders, and may also be any other output that requires composing of inputs.

FIG. 6 is a block diagram showing exemplary functions performed by a composer and exemplary logic for maintaining output item quality. The multiple inputs 602, may provide a streams of bytes for a layer which may represent graphics, a visual interface, a user interface, video, or any other layer for composing for an output. As indicated in the block diagram, each input, 602a-602d, may have a different format, for example, red green blue color model (RGB), red green blue alpha color model (RGBA), NV12 and other YUV pixel formats, although other similar input formats are also acceptable. As is shown by the exemplary formats of these inputs 602, several inputs may have the same format such as 606b and 606d, but it may be any combination of formats. Each input 602 provides data in an input item 604 for composing by the composer 110. This input item 604 may contain a data stream of each input 602, a packet of data, or any discrete amount of data which may be composed by the functions 606 of the composer 110 to provide to each output 608 an output item 610.

The functions 606a-606h of the composer 110 that are visualized here are examples only, and may vary in number and actual action performed. As listed, each function performs an action on the data. In this example, the data from input item 604d is scaled up in function 606a and then rotated in function 606b, as part of its composition with other layers, inputs, and input items. The data from input item 604c has a color space correction applied to it in function 606c and is then flipped in function 606d, as part of its composition with other layers, inputs, and input item formats. Data from input item 604b is scaled up in function 606e, as part of its composition with other layers, inputs, and input item formats. Data from input item 604a does not require any separate function for composition with other layers, inputs, or input items so progresses initially unchanged. Data from all inputs have the same alpha blend action applied in function 606f, in this example, in order to better compose each layer for the multiple outputs. The now unified layers of each input item are separately sent to each output each as an output item. For output item 616, no action is further needed. However, the combined layers are scaled down in function 606g as a composition step resulting in output item 610. At function 606h, the combined layers scaled down by function 606g are rotated. This rotation at function 606h occurs prior to the data being sent to Output 1, 608. The separate composing for these two outputs from this step is one aspect of the composer that allows it to use a single memory read operation. Stated another way, when the composer splits the data, the composer is then able to apply different operations to different copies of the same data to generate different output items. Splitting the data may include creating an exact copy of the intermediate data and store this copy in a memory region within the composer. It the splitting of data that allows the composer to avoid executing additional memory read operations of the initial inputs by utilizing an intermediate form of the data that will be common to both of the outputs. As this intermediate for of the data may be common to both outputs, recompilation of the initial steps of composition of this data is also avoided. Instead, only a few final functions need be applied to split data to generate the appropriate multiple output items. Prior composition engines would have to execute each of the pictured functions twice, once for each of the outputs here shown. However, enabling multiple outputs, as seen here, allows the combination of earlier functions on each of the input item formats, layers, and inputs.

The scale down function 606g for each of these layers is completed last, in part, to earlier preserve the quality of each layer needed for larger desired outputs, output items, displays, or encoders, in this example items 616, 614, and 618. This is in contrast to a composer that might scale down layers prior to a scale up action for a larger output, output item, or display. Proceeding in a scale down then scale up order of functions may result in the loss of detail from enlarging a now smaller layer rather than simply maintaining or enlarging from the original size. Other logical orderings of functions are contemplated in order to preserve the quality of the output item such as ordering and choosing functions to be applied in a way that reduces the number of functions that need to be applied. Another logical element includes the combination of functions that will be applied to the data from multiple input items at a time. This will reduce the number of manipulations needed and will reduce the GPU residency time and computational resources generally required by the composer.

These functions 606a-606g may also be applied separately to ensure that each output 610 and 614 is properly composed for an output 608 which may be displayed or encoded differently for Display 1 612, rather than Display 2 618. Output items 610 and 616 may include streams of data for each output 608 and 614, respectively. Output items 610 and 616 may also be in different sizes or formats in order to suit their respective outputs and the resulting displays. Each display 608 and 614 may vary in multiple aspects including size, orientation, and color format, each requiring a separate output item from each output.

### Example 1

A processing unit, including a memory that stores data to be used for generating multiple output items, a composer to execute a single memory read operation to obtain the data, split the data to generate the multiple output items, and perform a function on the data before the data is split if all of the multiple output items require the data to undergo this function, and a number of output buffers that each receive an output item from the composer and deliver that output item to an output. The processing unit may also include multiple inputs to the composer where each input has an input buffer from which the composer obtains data and an intermediate memory region to store data that is combined by the composer from the multiple input buffers before the data is split. Further, this processor may perform a function on uncombined data when the all of the output items require an adjustment be made only to the uncombined data. The composer of this processing unit may also perform a function on data that has been split when only the output items to receive this split data require the split data be adjusted by the function. The function performed by the composer may also be one of the following functions: color space conversion, scale, rotate, alpha blend, flip, chroma key, crop, align, transform, shear, or any combination thereof. The output of the processing unit may also be either an encoder or a display. This example processing may be a graphics processing unit for a mobile device. In this example, the composer may perform scaling functions on the data such that a scaling up function does not follow a scaling down function in order to preserve the quality of the output items delivered to the output buffers. The composer of the processing unit may also be a fixed function pipeline composer or a programmable pipeline composer.

### Example 2

A method of generating multiple output items with a composer, the method including obtaining data via a memory read operation, storing the data in an internal memory, generating multiple output items without executing an additional memory read operation by splitting, with the composer, the data stored in the memory, performing a function on the data before the data is split if every output item requires the data be adjusted by the function, and delivering each output item to its own output buffer. This method may also include providing data to the composer from multiple inputs each with its own input buffer, combining data from the multiple input buffers before the data is split, storing combined data in an intermediate memory, and sending the output item to an output with the output buffer. This example further contemplates performing a function on a particular uncombined data when all of the output items require an adjustment be made only to this particular uncombined data. The performing a function may also include performing the function on data that has been split when only the output items receiving this split data require the results of the function. Performing a function may include performing the function with the composer where the function is a color space conversion, scale, rotate, alpha blend, flip, chroma key, crop, align, transform, shear, or any combination thereof. This example method may involve generating the multiple output items with a composer that is either a programmable pipeline composer or a fixed function pipeline composer.

### Example 3

A non-transitory, machine accessible storage medium having instructions stored thereon that when executed on a machine to generate multiple output items by a composer cause the machine to obtain data from an input buffer with the composer, store the data in a memory region within the composer, combine data from the multiple input buffers and perform a function on the combined data before storing this combined data in an intermediate memory region, split the data stored in the intermediate memory region to generate multiple output items without executing another memory read operation from an input buffer, and send each output item its own output buffer for use in an output. The instructions in this example may perform a function on particular uncombined data when all of the output items require an adjustment that results from executing the function on the particular uncombined data. Also, the function may be a color space conversion, scale, rotate, alpha blend, flip, chroma key, crop, align, transform, shear, or any combination thereof. The non-transitory machine accessible storage medium contemplated may also have instructions further including that the composer may be either a programmable pipeline composer or a fixed function pipeline composer.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result. Further, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the functions described herein. A machine-readable medium may include any mechanism for storing or transmitting information in a form readable by a machine, e.g., a computer. For example, a machine-readable medium may include read only memory (ROM), random access memory (RAM), magnetic disk storage media, optical storage media, flash memory devices, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

Although functions may be described as a sequential process, some of the functions may in fact be performed in parallel, concurrently, and/or in a distributed environment, and with program code stored locally and/or remotely for access by single or multi-processor machines. In addition, in some embodiments the order of functions may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A processing unit, comprising:
a memory that stores data to be used for generating multiple output items;
a composer to execute a single memory read operation to obtain the data, split the data to generate the multiple output items, and perform a function on the data before the data is split if all of the multiple output items require the data to undergo this function; and
a plurality of output buffers that each receive an output item from the composer and deliver that output item to an output.

2. The processing unit recited in claim 1, comprising:
multiple inputs to the composer where each input has an input buffer from which the composer obtains data; and
an intermediate memory region to store data that is combined by the composer from the multiple input buffers before the data is split.

3. The processing unit recited in claim 2, the composer to perform a function on uncombined data when the all of the output items require an adjustment be made only to the uncombined data.

4. The processing unit recited in claim 1, the composer to perform a function on data that has been split when only the output items to receive this split data require the split data be adjusted by the function.

5. The processing unit of claim 1, the function performed by the composer being one of the following functions: color space conversion, scale, rotate, alpha blend, flip, chroma key, crop, align, transform, shear, or any combination thereof.

6. The processing unit of claim 1, wherein each output is either an encoder or a display.

7. The processing unit of claim 1, the processing unit being a graphics processing unit for a mobile device.

8. The processing unit of claim 1, the composer performing scaling functions on the data such that a scaling up function does not follow a scaling down function in order to preserve the quality of the output items delivered to the output buffers.

9. The processing unit of claim 1, wherein the composer is a fixed function pipeline composer or a programmable pipeline composer.

10. A method of generating multiple output items with a composer, the method comprising:
obtaining data via a memory read operation;
storing the data in an internal memory;
generating multiple output items without executing an additional memory read operation by splitting, with the composer, the data stored in the memory;
performing a function on the data before the data is split if every output item requires the data be adjusted by the function; and
delivering each output item to its own output buffer.

11. The method of claim 10, the method comprising:
providing data to the composer from multiple inputs each with its own input buffer;
combining data from the multiple input buffers before the data is split;
storing combined data in an intermediate memory; and
sending the output item to an output with the output buffer.

12. The method of claim 11, further comprising performing a function on a particular uncombined data when all of the output items require an adjustment be made only to this particular uncombined data.

14. The method of claim 10, performing a function on data that has been split when only the output items receiving this split data require the results of the function.

15. The method of claim 10, performing a function with the composer where the function is a color space conversion, scale, rotate, alpha blend, flip, chroma key, crop, align, transform, shear, or any combination thereof.

16. The method of claim 10 further comprising generating the multiple output items with a composer that is either a programmable pipeline composer or a fixed function pipeline composer.

17. A non-transitory, machine accessible storage medium having instructions stored thereon that when executed on a machine to generate multiple output items by a composer cause the machine to:
obtain data from an input buffer with the composer;
store the data in a memory region within the composer;
combine data from the multiple input buffers and perform a function on the combined data before storing this combined data in an intermediate memory region;
split the data stored in the intermediate memory region to generate multiple output items without executing another memory read operation from an input buffer; and
send each output item its own output buffer for use in an output.

18. The non-transitory machine accessible storage medium of claim 17, having instructions to perform a function on particular uncombined data when all of the output items require an adjustment that results from executing the function on the particular uncombined data.

19. The non-transitory machine accessible storage medium of claim 17, where the function is a color space conversion, scale, rotate, alpha blend, flip, chroma key, crop, align, transform, shear, or any combination thereof.

20. The non-transitory machine accessible storage medium of claim 17 having instructions further comprising the composer may be either a programmable pipeline composer or a fixed function pipeline composer.
